(19) United States
(12) Patent Application Publication
(10) Pub. No.: US 2016/0340252 A1
(43) Pub. Date: Nov. 24, 2016

(54) METHOD FOR PREPARING A GEO-POLYMER CONCRETE

(71) Applicants: Sesa Sterlite Limited, Odisha (IN); CSIR-INSTITUTE OF MINERALS AND MATERIALS TECHNOLOGY, Odisha (IN)

(72) Inventors: Mukesh KUMAR, New Delhi (IN); Bimalananda SENAPATI, Kolkata (IN); Chikkala Sateesh KUMAR, Andhra Pradesh (IN); Bansidhar NAYAK, Odisha (IN); Barada Kanta MISHRA, Odisha (IN); Syed Mohammed MUSTAKIM, Odisha (IN)

(21) Appl. No.: 14/825,158

(22) Filed: Aug. 12, 2015

(30) Foreign Application Priority Data
May 22, 2015 (IN) 562/KOL/2015

(51) Int. Cl. C04B 28/12; B28B 1/14

(52) U.S. Cl. CPC C04B 28/12; B28B 1/14

(57) ABSTRACT

The present disclosure provides a method of preparing a composition of a cold setting geo-polymer based building material. The cold-setting geo-polymer concrete is a green concrete that requires curing at ambient conditions. The method includes mixing one or more aggregates and a plurality of chemical ingredients in a mixing apparatus, and chemically activating an obtained geo-polymer concrete mix by adding an alkaline activator. The one or more aggregates include a plurality of stone chips and a plurality of sand particles. The plurality of chemical ingredients includes a fly ash and a calcium hydroxide solution. The fly ash includes one or more alumino-silicate aggregates. The fly ash, the plurality of sand particles and the calcium hydroxide solution, and the plurality of stone chips are mixed in a first pre-determined ratio. The alkaline activator prevents temperature curing of the cold-setting geo-polymer concrete.

### TECHNICAL FIELD

The present invention relates to the field of preparing a geo-polymer concrete composition, and in particular, relates to preparation of chemically activated cold setting geo-polymer concrete.

### BACKGROUND

In an emerging era of development, there is a rapid increase in constructional activities all over the world. Architectural and construction applications including building roads, bridges, commercial and residential buildings and the like require a significant amount of a construction material. The demand for concrete as the construction material is on an increase. Typically, the concrete can be a cement based concrete and a geo-polymer based concrete. The cement based concrete includes a Portland cement as a main ingredient. However, the cement based concrete results in global warming due to emission of greenhouse gases like carbon dioxide into atmosphere during its preparation. The geo-polymer based concrete includes a geo-polymer as a main ingredient. The geo-polymer based concrete is environmental friendly as it reduces the emission of the greenhouse gases into the atmosphere. Nowadays, due to this reason, the geo-polymer based concrete is increasingly being used as an alternative to the cement based concrete.

In general, the geo-polymers are synthesized from source materials that are rich in silica and alumina. The geo-polymer is prepared by dissolution and poly-condensation reactions between an alumino-silicate binder and an alkaline silicate solution. The alkaline silicate solution can be a mixture of an alkali metal silicate and a metal hydroxide. An outcome of this reaction is an amorphous three dimensional network of silicon and aluminium atoms linked together by oxygen atoms in a four-fold coordination similar to zeolites.

Presently known geo-polymer based concrete compositions require temperature curing in a range of 40-100 degree Celsius to attain a considerable compressive strength. This temperature curing is being fulfilled with the help of steam addition/condensate addition steam chambers and the like which is unsafe to handle concrete with high temperatures. Few other known geo-polymer based concrete compositions do not use lime for hardening. Further, mortar testing of concrete cubes for measuring its compressive strength is done on the concrete cubes of size 70×70×70 millimeters which is a typical standard for cement cube compressive strength testing. In addition, few of the geo-polymer based concrete often fail to offer a considerable chemical resistance, fire resistance and thermal insulation, abrasion resistance and the like.

In light of the above stated discussion, there is a need for a cold setting geo-polymer based concrete composition that overcomes the above stated disadvantages.

### SUMMARY

In an aspect of the present disclosure, a method of preparing a composition of a geo-polymer based building material is provided. The method includes mixing one or more aggregates and a plurality of chemical ingredients in a mixing apparatus to obtain a geo-polymer concrete mix, and chemically activating the obtained geo-polymer concrete mix by adding an alkaline activator. The one or more aggregates include a plurality of stone chips and a plurality of sand particles. The plurality of chemical ingredients includes a fly ash and a calcium hydroxide solution. The fly ash includes one or more alumino-silicate aggregates. The fly ash, the plurality of sand particles and the calcium hydroxide solution, and the plurality of stone chips are mixed in a first pre-determined ratio. The alkaline activator includes at least one of hydroxide selected from hydroxides of sodium, potassium and aluminium and at least one of silicate selected from silicates of sodium, potassium and aluminium, water and an accelerator. The at least one of hydroxide and the at least one of silicate are mixed in a second pre-determined ratio. The at least one of hydroxide and the at least one of silicate, and the water are mixed in an approximate ratio of 1:2. Further, 3 liters of the alkaline activator is added in every 50 kilograms of the geo-polymer concrete mix to obtain the geo-polymer based building material.

In an embodiment of the present disclosure, the first pre-determined ratio is 1:1:3 and the second pre-determined ratio is in a range of 1.0-1.5:3.0-3.5.

In an embodiment of the present disclosure, the accelerator includes one or more chemicals of alkali and alkaline metal having a quantity in a range of 0.01% to 0.06% by weight of the alkaline activator.

In an embodiment of the present disclosure, the method includes adding a plurality of red mud aggregates in the plurality of chemical ingredients. The fly ash and the plurality of red mud aggregates are present in an equal weight proportion along with the calcium hydroxide solution.

In an embodiment of the present disclosure, the fly ash and a plurality of red mud aggregates, the plurality of sand particles, and the plurality of stone chips are present in the geo-polymer concrete mix in a ratio of 1:2:3. The fly ash and the plurality of red mud aggregates are present in an equal weight proportion.

In another embodiment of the present disclosure, the fly ash and a plurality of red mud aggregates, the plurality of sand particles, and the plurality of stone chips are present in the geo-polymer concrete mix in a ratio of 1:1.5:3. The fly ash and the plurality of red mud aggregates are present in an equal weight proportion.

In yet another embodiment of the present disclosure, the fly ash and a plurality of red mud aggregates, the plurality of sand particles, and the plurality of stone chips are present in the geo-polymer concrete mix in a ratio of 1:1:3. The fly ash and the plurality of red mud aggregates are present in an equal weight proportion.

In an embodiment of the present disclosure, a caustic fly ash slurry is added in a mixing apparatus to control consistency in mixing.

In another aspect of the present disclosure, a method of preparing a composition of a geo-polymer based building material is provided. The method includes mixing one or more aggregates and a plurality of chemical ingredients in a mixing apparatus to obtain a geo-polymer concrete mix, grinding the geo-polymer concrete mix, chemically activating the obtained uniform powdered material of the grinded geo-polymer concrete mix by adding an alkaline activator, and operating the chemically activated uniform powdered material. The one or more aggregates include a plurality of stone chips and a plurality of sand particles. The plurality of chemical ingredients includes a fly ash and a calcium hydroxide solution. The fly ash includes one or more alumino-silicate aggregates. The fly ash, the plurality of sand particles and the calcium hydroxide solution, and the plurality of stone chips are mixed in a first pre-determined ratio. The geo-polymer concrete mix is grinded to obtain a uniform powdered material. The alkaline activator includes at least one of hydroxide selected from hydroxides of sodium, potassium and aluminium and at least one of silicate selected from silicates of sodium, potassium and aluminium, water and an accelerator. The at least one of hydroxide and the at least one of silicate are mixed in a second pre-determined ratio. The at least one of hydroxide and the at least one of silicate, and the water are mixed in an approximate ratio of 1:4. The accelerator includes one or more chemicals of alkali and alkaline metal having a quantity in a range of 0.01% to 0.06% by weight of the alkaline activator. The chemically activated uniform powdered material is operated to obtain the geo-polymer based building material. Further, 3 liters of the alkaline activator is added in every 50 kilograms of the geo-polymer concrete mix to obtain the geo-polymer based building material.

In an embodiment of the present disclosure, the first pre-determined ratio is 1:1:3 and the second pre-determined ratio is in a range of 1.0-1.5:3.0-3.5.

In an embodiment of the present disclosure, the alkaline activator facilitates an atmosphere curing of the geo-polymer based building material. The alkaline activator prevents a temperature curing of the geo-polymer based building material.

In an embodiment of the present disclosure, strength of the geo-polymer based building material is in a range of 10 Mega Pascal to 50 Mega Pascal.

In an embodiment of the present disclosure, dimensions of each of a plurality of alumino-silicate cubings casted from the composition are 150×150×150 millimeters.

In an embodiment of the present disclosure, the fly ash is a class F fly ash.

In an embodiment of the present disclosure, the fly ash, the plurality of sand particles and the plurality of stone chips are present in the geo-polymer concrete mix in a ratio of 1:2:3.

In another embodiment of the present disclosure, the fly ash, the plurality of sand particles and the plurality of stone chips are present in the geo-polymer concrete mix in a ratio of 1:1.5:3.

In yet another embodiment of the present disclosure, the fly ash, the plurality of sand particles and the plurality of stone chips are present in the geo-polymer concrete mix in a ratio of 1:1:3.

In yet another embodiment of the present disclosure, a method of preparing a composition of a geo-polymer based building material is provided. The method includes mixing one or more aggregates and a plurality of chemical ingredients in a mixing apparatus to obtain a geo-polymer concrete mix, grinding the geo-polymer concrete mix, chemically activating the obtained uniform powdered material of the geo-polymer concrete mix by adding an alkaline activator, operating the chemically activated uniform powdered material, and casting a plurality of alumino-silicate cubings. The one or more aggregates include a plurality of stone chips and a plurality of sand particles. The plurality of chemical ingredients includes a fly ash and a calcium hydroxide solution. The fly ash includes one or more alumino-silicate aggregates. The fly ash, the plurality of sand particles and the calcium hydroxide solution, and the plurality of stone chips are mixed in a first pre-determined ratio. The geo-polymer concrete mix is grinded to obtain a uniform powdered material. The alkaline activator includes at least one of hydroxide selected from hydroxides of sodium, potassium and aluminium and at least one of silicate selected from silicates of sodium, potassium and aluminium, water and an accelerator. The at least one of hydroxide and the at least one of silicate are mixed in a second pre-determined ratio. The at least one of hydroxide and the at least one of silicate, and the water are mixed in an approximate ratio of 1:6. The accelerator includes one or more chemicals of alkali and alkaline metal having a quantity in a range of 0.01% to 0.06% by weight of the alkaline activator. The chemically activated uniform powdered material is operated to obtain the geo-polymer based building material. The plurality of alumino-silicate cubings is casted from the geo-polymer based building material and each has dimensions of 150×150×150 millimeters. Further, 3 liters of the alkaline activator is added in every 50 kilograms of the geo-polymer concrete mix to obtain the geo-polymer based building material.

In an embodiment of the present disclosure, the first pre-determined ratio is 1:1:3 and the second pre-determined ratio is in a range of 1.0-1.5:3.0-3.5.

In an embodiment of the present disclosure, a molarity concentration of the at least one of hydroxide is based on a volume ratio of the at least one of hydroxide to the at least one of silicate and a quantity of the at least one of hydroxide mixed in the water to prepare a 1 litre solution of the at least one of hydroxide.

### BRIEF DESCRIPTION OF THE FIGURES

Having thus described the invention in general terms, reference will now be made to the accompanying drawings, which are not necessarily drawn to scale, and wherein:

FIG. 1 illustrates a flow chart for describing a method for preparing a composition of a geo-polymer based building material, in accordance with an embodiment of the present disclosure;

FIG. 2 illustrates a flow chart for describing a method for preparing a composition of a geo-polymer based building material, in accordance with another embodiment of the present disclosure;

FIG. 3 illustrates a flow chart for describing a method for preparing a composition of a geo-polymer based building material, in accordance with yet another embodiment of the present disclosure; and

FIG. 4 illustrates a table describing applications of a geo-polymer based concrete, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

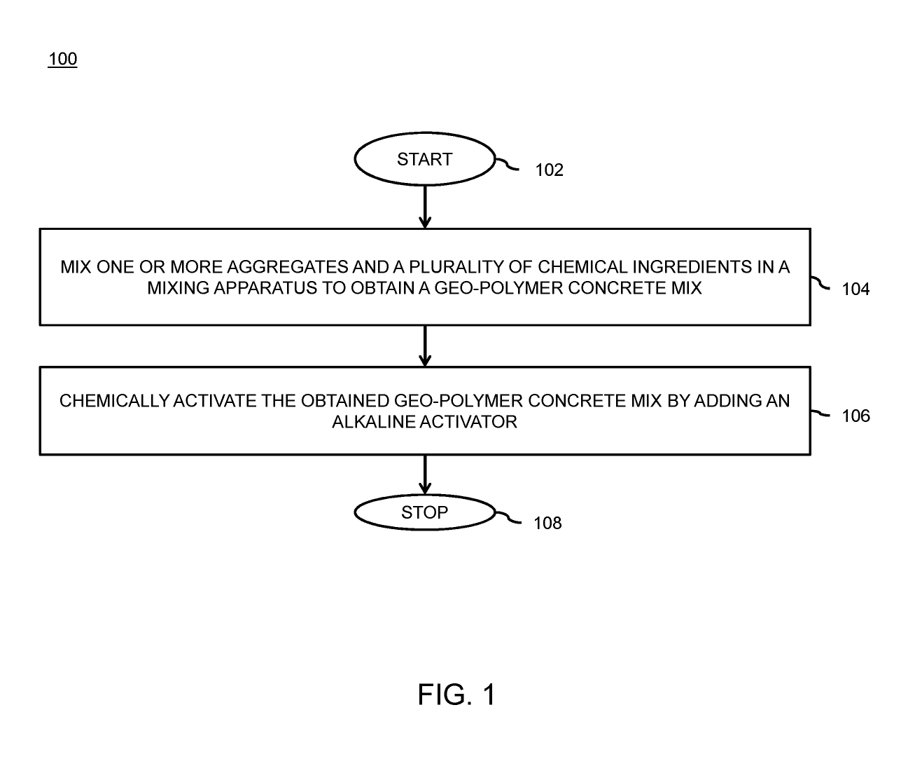

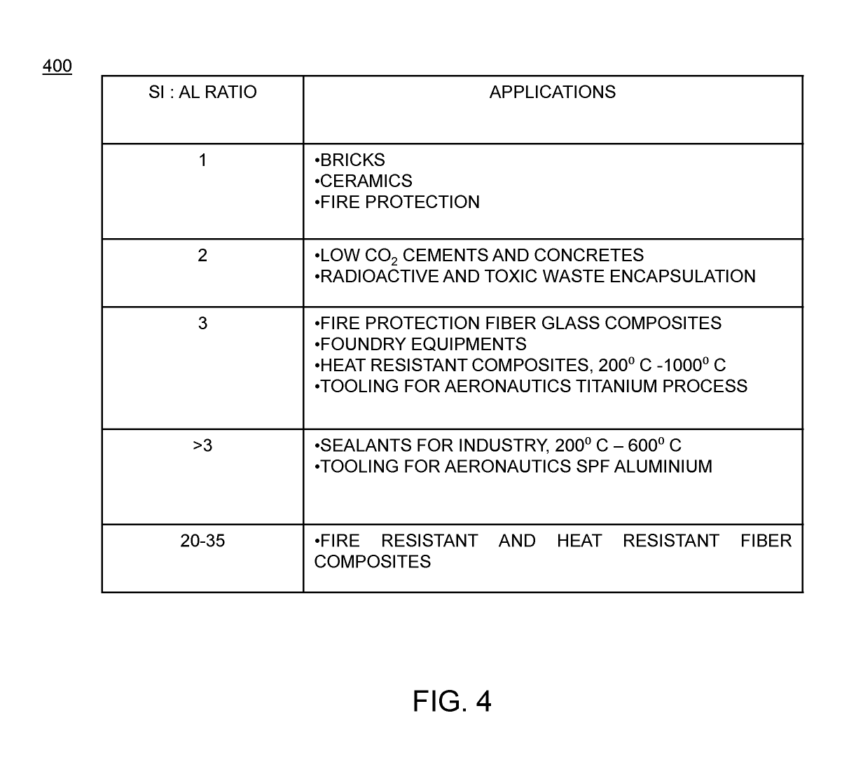

FIG. 1 illustrates a flow chart 100 for describing a method for preparing a composition of a geo-polymer based building material, in accordance with an embodiment of the present disclosure. The geo-polymer is a family of mineral binders with a chemical composition similar to zeolites but with an amorphous microstructure. Further, the geo-polymer is a class of inorganic polymer formed as a reactant product of alumina and silica in presence of an alkali which is produced by a geo-chemical reaction process. The geo-polymer based building material is the geo-polymer and a cement-free concrete possessing a variety of applications in the field of building and construction (as elaborately described in detailed description of FIG. 4). For example, the geo-polymer based building material is utilized for construction of roads and pathways, pre-cast slabs, buildings, floorings, walls, foundations and the like. Further, the geo-polymer based building material possesses greatest potential application for transport infrastructure.

The flow chart 100 initiates at step 102. Following step 102, step 104 describes mixing one or more aggregates and a plurality of chemical ingredients in a mixing apparatus to obtain a geo-polymer concrete mix. In an embodiment of the present disclosure, quantity of the geo-polymer concrete mix utilized for preparing the composition of the geo-polymer based building material is about 50 kilograms. The one or more aggregates include a plurality of stone chips and a plurality of sand particles. Moreover, size of each of the one or more aggregates is less than 20 millimeters. In an embodiment of the present disclosure, the plurality of stone chips acts as coarse aggregates and the plurality of sand particles acts as fine aggregates. Further, a fineness modulus of the plurality of sand particles is approximately 2.94 millimeters and is calculated by dividing a sum of percentages of each of the plurality of sand particles of different sizes present in the geo-polymer concrete mix by 100. In an embodiment of the present disclosure, a quantity of the plurality of stone chips added in 50 kilograms of the geo-polymer concrete mix is about 30 kilograms. In an embodiment of the present disclosure, a quantity of the plurality of sand particles put into use is about 9 kilograms.

The plurality of chemical ingredients includes a fly ash and a calcium hydroxide solution. The fly ash, the plurality of sand particles and the calcium hydroxide solution, and the plurality of stone chips are mixed in a first pre-determined ratio. The first pre-determined ratio is approximately 1:1:3. A quantity of the fly ash utilized for preparing the geo-polymer concrete mix is about 10 kilograms and a quantity of the calcium hydroxide utilized to make its 1 litre solution is about 1 kilogram. Moreover, the mixing apparatus is a geo-polymer concrete mixer that homogeneously combines the one or more aggregates, the fly ash, the calcium hydroxide solution and/or other aggregates or chips.

The fly ash is one of the residues generated in combustion. More particularly, the fly ash refers to ash produced during the combustion of coal. The fly ash includes one or more alumino-silicate aggregates. In an embodiment of the present disclosure, the one or more alumino-silicate aggregates required in the composition come from the fly ash. In another embodiment of the present disclosure, the one or more alumino-silicate aggregates are the alumino-silicates obtained from natural minerals that include a kaolinite, a clay, a mica, an alunite, a spinel or any other mineral whose empirical formula includes silicon, aluminium and oxygen. Generally, the one or more alumino-silicate aggregates are formed by a chemical reaction of alumino-silicate oxides (Al₂O₂ and Si₂O₅) with alkali poly-silicates yielding polymeric Si—O—Al bonds. The poly-silicates are generally sodium or potassium silicate supplied by a chemical industry or manufactured fine silica powder generated as a by-product of ferro-silicon metallurgy.

Moreover, the fly ash utilized in the composition is a class F fly ash. The class F fly ash has low calcium content and contains 80-85% of the silica and the alumina. Other compounds present in the fly ash include iron oxide, titanium oxide, calcium oxide, magnesium oxide, manganese oxide, sodium oxide and potassium oxide. In addition a ratio of the silica to the alumina present in the fly ash is approximately 1.97. Generally, the low calcium fly ash is preferred as an ingredient of the geo-polymer concrete mix as presence of the calcium in high amounts may interfere with polymerization process and alter its microstructure. The fly ash has a specific gravity of 2.05 and a dry bulk density of 1080 kilograms per meter cube.

Apart from chemical composition, other characteristics of the fly ash that generally considered are loss on ignition (hereinafter ‘LOI’), fineness and uniformity. The LOI of the fly ash is approximately 3.80%. The LOI is a measurement of unburnt carbon remaining in ash. The Fineness of the fly ash depends on operating conditions of coal crushers and grinding process of the coal itself. Finer gradation generally results in a more reactive ash and contains less carbon. Characteristics that influence suitability of the fly ash for the geo-polymer concrete mix are particle size, amorphous content, morphology and origin of the fly ash.

In an embodiment of the present disclosure, the low-calcium fly ash may have an approximate percentage of unburned material (LOI) of less than 5%, a content of the iron oxide not exceeding 10%, a low content of the calcium oxide, a content of reactive silica in a range of 40-50% and size of its 80-90% particles smaller than 45 μm. In another embodiment of the present disclosure, the fly ash has a higher content of the calcium oxide that contributes a higher compressive strength due to formation of calcium-aluminate-hydrate and other calcium compounds.

In another embodiment of the present disclosure, the plurality of chemical ingredients includes the fly ash, a plurality of red mud aggregates and the calcium hydroxide solution. The fly ash and the plurality of red mud aggregates are present in an equal weight proportion. The plurality of red mud aggregates has a specific gravity of 2.84 and a dry bulk density of 1320 kilograms per meter cube. The plurality of red mud aggregates includes the silica and the alumina, the iron oxide, the titanium oxide, the calcium oxide, the magnesium oxide, the manganese oxide, the sodium oxide and the potassium oxide. Further, the LOI of the plurality of red mud aggregates is approximately 9.48%.

In an embodiment of the present disclosure, the plurality of chemical ingredients further includes slag, rice-husk ash and the like. Choice of materials required for preparing the geo-polymer concrete mix depends on factors including availability, cost, type of application, specific demand of end users and the like. In an embodiment of the present disclosure, the fly ash, the plurality of sand particles and the calcium hydroxide solution, and the plurality of stone chips are present in the geo-polymer concrete mix in an approximate ratio of 1:1:3.

The calcium hydroxide solution, also referred to as slaked lime includes an approximate of 85% of the calcium hydroxide with other ingredients including active calcium oxide, the silica, iron, the alumina, magnesia and carbonate in relatively smaller quantities.

Step 106 deals with chemically activating the obtained geo-polymer concrete mix by adding an alkaline activator. Depending upon the quantities of ingredients of the geo-polymer concrete mix (described above), 3 litres of the alkaline activator is added to the geo-polymer concrete mix. The alkaline activator includes at least one of hydroxide selected from hydroxides of sodium, potassium and aluminium and at least one of silicate selected from silicates of sodium, potassium and aluminium, water and an accelerator. The at least one of hydroxide and the at least one of silicate is mixed in a second pre-determined ratio. The second pre-determined ratio is in a range of 1.0-1.5:3.0-3.5. In an embodiment of the present disclosure, the alkaline activator may include sodium hydroxide solution or sodium hydroxide solid flakes.

In an embodiment of the present disclosure, the alkaline activator is prepared by mixing a plurality of sodium hydroxide flakes in a sodium silicate solution. Further, due to presence of the plurality of sodium hydroxide flakes, the alkaline activator is alkaline in nature. In an embodiment of the present disclosure, the sodium silicate solution has a specific gravity in a range of 1.56-1.66, the sodium oxide in a range of 15.5%-16.5% by weight of the sodium silicate solution, the silica in a range of 31.0%-33.0% by weight of the sodium silicate solution, a molar ratio in a range of 2.0±0.05, a weight ratio in a range of 1.20±0.1 and an iron content of less than 100 parts per million.

Moreover, presence of the alkaline activator eliminates a heat curing process. The heat curing process involves temperature curing of the geo-polymer based building material (geo-polymer based concrete) in a range of 40-60 degree Celsius to attain a required strength. However, the composition of geo-polymer based building material do not require the so-called much needed heat/temperature curing process, instead it is prepared at ambient conditions. The alkaline activator is solely responsible for facilitating an atmospheric curing of the composition. More particularly, the presence of the plurality of sodium hydroxide flakes and the sodium silicate solution in the alkaline activator releases an enormous amount of heat which is capable of facilitating the atmospheric curing of the composition. Thus, reaction between the plurality of sodium hydroxide flakes and the sodium silicate solution is highly exothermic that it completely eliminates the heat curing process.

Further, due to the elimination of the heat curing process, the geo-polymer based concrete is referred to as cold setting geo-polymer concrete. Furthermore, the geo-polymer based concrete is referred to as cold setting geo-polymer concrete due to its properties of fast setting in ambient conditions.

Further, the at least one of hydroxide and the at least one of silicate, and the water is mixed in an approximate ratio of 1:2. The composition of the geo-polymer based concrete for the 1:2 ratio of the at least one of hydroxide and the at least one of silicate to the water includes the fly ash of about 10 kilograms, the plurality of sand particles of about 9 kilograms, the calcium hydroxide of about 1 kilogram in 1 litre of its solution, the plurality of stone chips of about 30 kilograms along with 3 litres of the alkaline activator. The alkaline activator facilitates cold setting of the geo-polymer based concrete for gaining the required compressive strength. The composition of the geo-polymer based building material is utilized for casting a plurality of alumino-silicate cubings at atmospheric conditions, each of size 150×150×150 millimeters. Further, the plurality of alumino-silicate cubings are casted from the composition by utilizing conventional means including a vibration, a compaction, an extrusion through machine, a hand mold technique and the like. In an embodiment of the present disclosure, the plurality of alumino-silicate cubings is casted by hand ramming/poking in three layers. Moreover, number of the plurality of alumino-silicate cubings casted from this composition are 6.

Mortar test is utilized to determine compressive strength of each of the plurality of alumino-silicate cubings, each having size of 150×150×150 millimeters. The Mortar test is a standard for concrete compressive strength testing to be done with concrete cubes of size of 150×150×150 millimeters and raw materials like the plurality of stone chips, the plurality of sand particles, the fly ash and the calcium hydroxide solution are usually used. Each of the plurality of alumino-silicate cubings attains a cube crushing strength of 21 Mega Pascal in 3 days, a cube crushing strength of 34 Mega Pascal in 7 days, a cube crushing strength of 41 Mega Pascal in 14 days and a cube crushing strength of 46 Mega Pascal in 21 days.

Further, the atmospheric curing performed by utilizing the alkaline activator enables the geo-polymer based concrete to attain a required amount of compressive strength. In an embodiment of the present disclosure, each of the plurality of alumino-silicate cubings is de-moulded and exposed for the atmospheric curing. In an embodiment of the present disclosure, strength of the geo-polymer based concrete is in a range of 10 Mega Pascal to 50 Mega Pascal. Moreover, various parameters are responsible for influencing the compressive strength of the geo-polymer based concrete. The parameters include a ratio of the water to the geo-polymer concrete mix, a ratio of the at least one of hydroxide and the at least one of silicate to the fly ash, a ratio of the sodium silicate solution to the plurality of sodium hydroxide flakes (Na₂SiO₃:NaOH) and a molar concentration of the plurality of sodium hydroxide flakes.

When the ratio of the water to geo-polymer concrete mix (by mass) decreases, the compressive strength of the geo-polymer based building material increases. Further, as the ratio of the at least one of hydroxide and the at least one of silicate to the fly ash increases, the compressive strength of the geo-polymer based building material increases. Furthermore, as the ratio of the sodium silicate solution to the plurality of sodium hydroxide flakes (Na₂SiO₃:NaOH) increases, the compressive strength of the geo-polymer based building material increases. In addition, a higher molar concentration of the sodium hydroxide in its solution results in the higher compressive strength. In an embodiment of the present disclosure, a molarity concentration of the sodium hydroxide solution is based on a volume ratio of a sodium hydroxide solution to the sodium silicate solution.

In another embodiment of the present disclosure, a molarity concentration of the sodium hydroxide solution is based on a quantity of the plurality of sodium hydroxide flakes mixed in the water to prepare 1 litre of the sodium hydroxide solution. In an embodiment of the present disclosure, an approximate 80 grams of the plurality of sodium hydroxide flakes is mixed with the water to obtain an approximate molar concentration of 2 of the sodium hydroxide solution, an approximate 160 grams of the plurality of sodium hydroxide flakes is mixed with the water to obtain an approximate molar concentration of 4 of the sodium hydroxide solution, an approximate 240 grams of the plurality of sodium hydroxide flakes is mixed with the water to obtain an approximate molar concentration of 6 of the sodium hydroxide solution, an approximate 320 grams of the plurality of sodium hydroxide flakes is mixed with the water to obtain an approximate molar concentration of 8 of the sodium hydroxide solution, an approximate 400 grams of the plurality of sodium hydroxide flakes is mixed with the water to obtain an approximate molar concentration of 10 of the sodium hydroxide solution and an approximate 480 grams of the plurality of sodium hydroxide flakes is mixed with the water to obtain an approximate molar concentration of 12 of the sodium hydroxide solution.

The accelerator includes one or more chemicals of alkali and alkaline metal. An amount of the accelerator added is in a range of 0.01%-0.06% by weight of the alkaline activator. Further, a caustic fly ash slurry is added in the mixing apparatus to control consistency in mixing. The flow chart 100 terminates at step 108.

It may be noted that the FIG. 1 lists and mentions quantities of the various constituents of the geo-polymer concrete mix (for example, 30 kilograms of the plurality of stone chips, 10 kilograms of the fly ash, 9 kilograms of the plurality of sand particles and 1 kilogram of the calcium hydroxide in the 1 litre of its solution); however those skilled in the art would appreciate that the composition may be prepared by adding the constituents in other concentrations as well, however concentrations of quantities of further added materials should be in a proportion to the concentration of quantities of the previously added constituents. In simpler terms, if concentration of a constituent is changed, then the constituents added to it later on should be such that it should not disturb an overall proportion of the concentrations of the constituents.

It may also be noted that the flow chart 100 is explained to have above stated process steps; however, those skilled in the art would appreciate that the flow chart 100 may have more/less number of process steps which may enable all the above stated embodiments of the present disclosure.

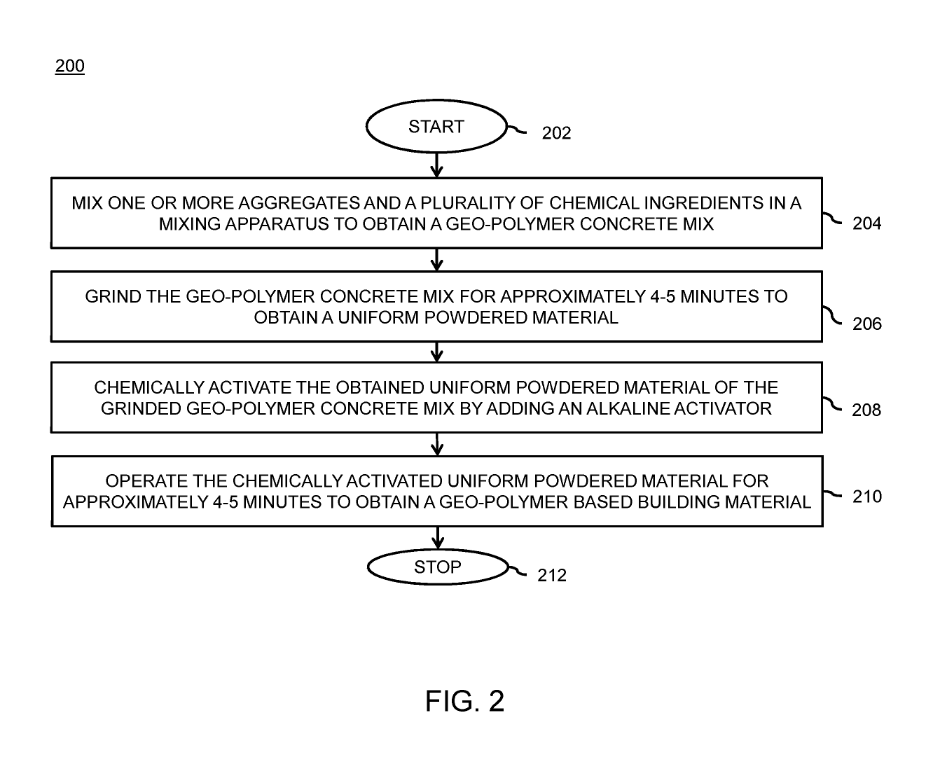

FIG. 2 illustrates a flow chart 200 for describing a method for preparing a composition of a geo-polymer based building material, in accordance with another embodiment of the present disclosure. As described in the detailed description of FIG. 1, the geo-polymer is the family of mineral binders with the chemical composition similar to the zeolites but with the amorphous microstructure. In addition, the geo-polymer is a class of inorganic polymer formed as the reactant product of the alumina and the silica in the presence of the alkali which is produced by the geo-chemical reaction process. The geo-polymer based building material is the geo-polymer and a cement-free concrete possessing a variety of applications in the field of building and construction. For example, the geo-polymer based building material is utilized for construction of roads and pathways, pre-cast slabs, buildings, floorings, walls, foundations and the like. Further, the geo-polymer based building material possesses greatest potential application for transport infrastructure.

The flow chart 200 initiates at step 202. Following step 202, step 204 describes mixing one or more aggregates and a plurality of chemical ingredients in a mixing apparatus to obtain a geo-polymer concrete mix. In an embodiment of the present disclosure, quantity of the geo-polymer concrete mix utilized for preparing the composition of the geo-polymer based building material is about 50 kilograms. The one or more aggregates include a plurality of stone chips and a plurality of sand particles (as described elaborately in detailed description of FIG. 1).

Further, the plurality of chemical ingredients includes a fly ash and a calcium hydroxide solution. The fly ash, the plurality of sand particles and the calcium hydroxide solution, and the plurality of stone chips are mixed in a first pre-determined ratio. The first pre-determined ratio is approximately 1:1:3. A quantity of the fly ash utilized for preparing the geo-polymer concrete mix is about 10 kilograms and a quantity of the calcium hydroxide utilized to make its solution is about 1 kilogram. The mixing apparatus is a geo-polymer concrete mixer that homogeneously combines the one or more aggregates, the fly ash, the calcium hydroxide solution and/or other aggregates or chips (as described elaborately in detailed description of FIG. 1).

The fly ash is one of the residues generated in combustion. More particularly, the fly ash refers to the ash produced during the combustion of coal. The fly ash includes one or more alumino-silicate aggregates (as described elaborately in detailed description of FIG. 1). In another embodiment of the present disclosure, the plurality of chemical ingredients includes the fly ash, a plurality of red mud aggregates and the calcium hydroxide solution (as described elaborately in detailed description of FIG. 1).

The calcium hydroxide solution, also referred to as slaked lime includes an approximate of 85% of the calcium hydroxide with other ingredients including active calcium oxide, the silica, iron, the alumina, magnesia and carbonate in relatively smaller quantities.

In an embodiment of the present disclosure, the plurality of chemical ingredients further includes slag, rice-husk ash and the like. Choice of materials required for preparing the geo-polymer concrete mix depends on factors including availability, cost, type of application, specific demand of end users and the like. In an embodiment of the present disclosure, the fly ash, the plurality of sand particles and the calcium hydroxide solution, and the plurality of stone chips are present in the geo-polymer concrete mix in a ratio of 1:1:3 (as described elaborately in detailed description of FIG. 1).

Step 206 describes grinding the geo-polymer concrete mix for approximately 4-5 minutes in the mixing apparatus to obtain a uniform powdered material. Step 208 deals with chemically activating the obtained uniform powdered material of the grinded geo-polymer concrete mix by adding the alkaline activator. Depending upon the quantities of ingredients of the geo-polymer concrete mix (described above), 3 litres of the alkaline activator is added to the geo-polymer concrete mix. The alkaline activator includes at least one of hydroxide selected from the hydroxides of sodium, potassium and aluminium and at least one of silicate selected from the silicates of sodium, potassium and aluminium, water and an accelerator. The at least one of hydroxide and the at least one of silicate is mixed in a second pre-determined ratio. The second pre-determined ratio is in a range of 1.0-1.5:3.0-3.5 (as described in detailed description of FIG. 1).

In an embodiment of the present disclosure, the alkaline activator is prepared by mixing a plurality of sodium hydroxide flakes with a sodium silicate solution as described elaborately in detailed description of FIG. 1. The accelerator includes one or more chemicals of alkali and alkaline metal. An amount of the accelerator added is in a range of 0.01%-0.06% by weight of the alkaline activator. Further, a caustic fly ash slurry is added in the mixing apparatus to control consistency in mixing (as described in detailed description of FIG. 1). Step 210 deals with operating the chemically activated uniform powdered material for approximately 4-5 minutes in the mixing apparatus to obtain the geo-polymer based building material.

In an embodiment of the present disclosure, the at least one of hydroxide and the at least one of silicate, and the water is mixed in an approximate ratio of 1:4. The composition of the geo-polymer based concrete for the 1:4 ratio of the alkaline activator to the water includes the fly ash of about 10 kilograms, the plurality of sand particles of about 9 kilograms, the calcium hydroxide of about 1 kilogram in its solution, the plurality of stone chips of about 30 kilograms along with 3 litres of the alkaline activator. The alkaline activator facilitates the cold setting of the geo-polymer based concrete for gaining the required compressive strength. Moreover, number of a plurality of alumino-silicate cubings casted from this composition are 6.

Further, Mortar test is utilized to determine the compressive strength of each of the plurality of alumino-silicate cubings, each having size of 150×150×150 millimeters. Each of the plurality of alumino-silicate cubings attains a cube crushing strength of 16 Mega Pascal in 3 days, a cube crushing strength of 26 Mega Pascal in 7 days, a cube crushing strength of 32 Mega Pascal in 14 days and a cube crushing strength of 35 Mega Pascal in 21 days.

Moreover, presence of the alkaline activator eliminates a heat curing process. The heat curing process involves temperature curing of the geo-polymer based building material (geo-polymer based concrete) in a range of 40-100 degree Celsius to attain a required strength. However, the composition of geo-polymer based building material do not require the so-called much needed heat/temperature curing process, instead it is prepared at ambient conditions (as described in detailed description of FIG. 1).

Further, the atmospheric curing performed by utilizing the alkaline activator enables the geo-polymer based concrete to attain the required amount of compressive strength (as stated above). In an embodiment of the present disclosure, each of the plurality of alumino-silicate cubings is de-moulded and exposed for the atmospheric curing. Moreover, various parameters are responsible for influencing the compressive strength of the geo-polymer based concrete (as described elaborately in detailed description of FIG. 1). The flow chart 200 terminates at step 212.

It may be noted that the flow chart 200 is explained to have above stated process steps; however, those skilled in the art would appreciate that the flow chart 200 may have more/less number of process steps which may enable all the above stated embodiments of the present disclosure.

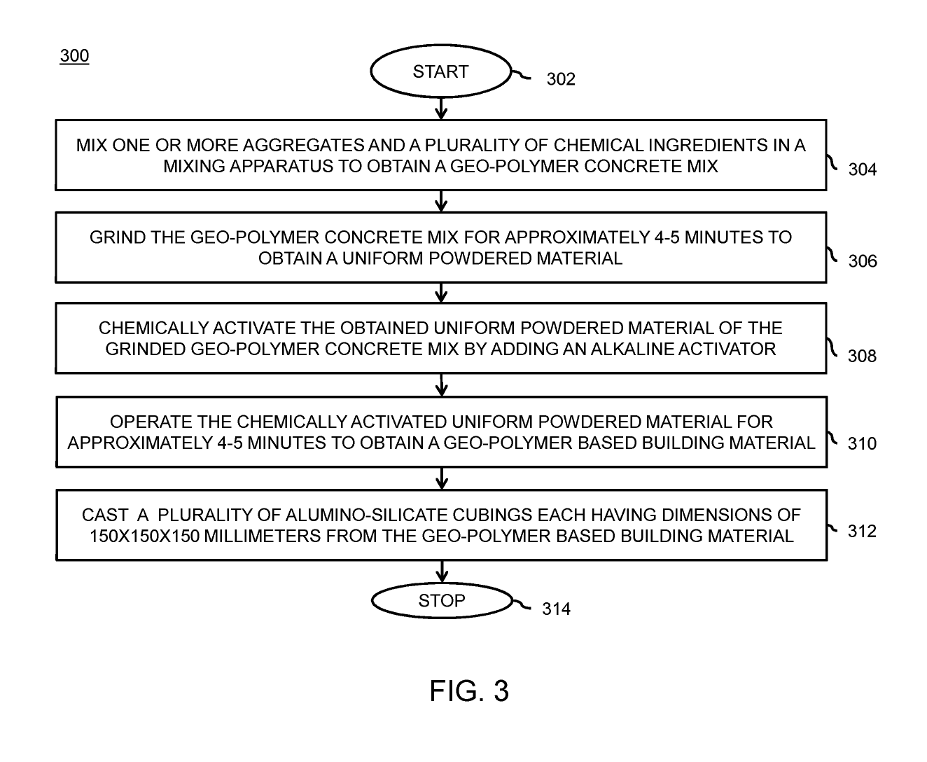

FIG. 3 illustrates a flow chart 300 for describing a method for preparing a composition of a geo-polymer based building material, in accordance with yet another embodiment of the present disclosure. As described in the detailed description of FIG. 1 and FIG. 2, the geo-polymer is the family of mineral binders with the chemical composition similar to the zeolites but with the amorphous microstructure. In addition, the geo-polymer is the class of the inorganic polymer formed as the reactant product of the alumina and the silica in presence of the alkali which is produced by the geo-chemical reaction process. The geo-polymer based building material is the geo-polymer and a cement-free concrete possessing a variety of applications in the field of building and construction. For example, the geo-polymer based building material is utilized for construction of roads and pathways, pre-cast slabs, buildings, floorings, walls, foundations and the like. Further, the geo-polymer based building material possesses greatest potential application for transport infrastructure.

The flow chart 300 initiates at step 302. Following step 302, step 304 describes mixing one or more aggregates and a plurality of chemical ingredients in a mixing apparatus to obtain a geo-polymer concrete mix. In an embodiment of the present disclosure, a quantity of the geo-polymer concrete mix utilized for preparing the composition of the geo-polymer based building material is about 50 kilograms. The one or more aggregates include a plurality of stone chips and a plurality of sand particles (as described elaborately in detailed description of FIG. 1).

Further, the plurality of chemical ingredients includes a fly ash and a calcium hydroxide solution (as described elaborately in detailed description of FIG. 1). The fly ash, the plurality of sand particles and the calcium hydroxide solution, and the plurality of stone chips are mixed in a first pre-determined ratio. The first pre-determined ratio is approximately 1:1:3. A quantity of the fly ash utilized for preparing the geo-polymer concrete mix is about 10 kilograms and a quantity of the calcium hydroxide utilized to make its solution is about 1 kilogram (as described elaborately in detailed description of FIG. 1).

The fly ash is one of the residues generated in the combustion. More particularly, the fly ash refers to the ash produced during the combustion of coal. The fly ash includes the one or more alumino-silicate aggregates (as described elaborately in detailed description of FIG. 1). In another embodiment of the present disclosure, the plurality of chemical ingredients includes the fly ash, a plurality of red mud aggregates and the calcium hydroxide solution (as described elaborately in detailed description of FIG. 1).

The calcium hydroxide solution, also referred to as slaked lime includes an approximate of 85% of the calcium hydroxide with other ingredients including active calcium oxide, the silica, iron, the alumina, magnesia and carbonate in relatively smaller quantities (as described in detailed description of FIG. 1 and FIG. 2).

In an embodiment of the present disclosure, the plurality of chemical ingredients further includes slag, rice-husk ash and the like. Choice of materials required for preparing the geo-polymer concrete mix depends on factors including availability, cost, type of application, specific demand of end users and the like. In an embodiment of the present disclosure, the fly ash, the plurality of sand particles and the calcium hydroxide solution, and the plurality of stone chips are present in the geo-polymer concrete mix in a ratio of 1:1:3 (as described elaborately in detailed description of FIG. 1 and FIG. 2).

Step 306 describes grinding the geo-polymer concrete mix for approximately 4-5 minutes in the mixing apparatus to obtain a uniform powdered material. Step 308 deals with chemically activating the obtained uniform powdered material of the grinded geo-polymer concrete mix by adding the alkaline activator. Depending upon the quantities of ingredients of the geo-polymer concrete mix (described above), 3 litres of the alkaline activator is added to the geo-polymer concrete mix. The alkaline activator includes at least one of hydroxide selected from the hydroxides of sodium, potassium and aluminium and at least one of silicate selected from the silicates of sodium, potassium and aluminium, water and an accelerator. The at least one of hydroxide and the at least one of silicate is mixed in a second pre-determined ratio. The second pre-determined ratio is in a range of 1.0-1.5:3.0-3.5 (as described in detailed description of FIG. 1).

In an embodiment of the present disclosure, the alkaline activator is prepared by mixing a plurality of sodium hydroxide flakes with a sodium silicate solution as described elaborately in detailed description of FIG. 1. The accelerator includes one or more chemicals of alkali and alkaline metal. An amount of the accelerator added is in a range of 0.01%-0.06% by weight of the alkaline activator. Further, a caustic fly ash slurry is added in the mixing apparatus to control the consistency in the mixing (as described in detailed description of FIG. 1). Step 310 deals with operating the chemically activated uniform powdered material for approximately 4-5 minutes in the mixing apparatus to obtain the geo-polymer based building material. Step 312 describes casting a plurality of alumino-silicate cubings each having dimensions of 150×150×150 millimeters from the geo-polymer based building material.

In an embodiment of the present disclosure, the at least one of hydroxide and the at least one of silicate, and the water is mixed in an approximate ratio of 1:6. The composition of the geo-polymer based concrete for the 1:6 ratio of the alkaline activator to the water includes a first case and a second case. The first case includes testing the compressive strength of each of the plurality of alumino-silicate cubings casted from a first composition including the fly ash of about 10 kilograms, the plurality of sand particles of about 9 kilograms, the calcium hydroxide of about 1 kilogram in its solution, the plurality of stone chips of about 30 kilograms along with 3 litres of the alkaline activator. The alkaline activator facilitates the cold setting of the geo-polymer based concrete for gaining the required compressive strength. Moreover, number of the plurality of alumino-silicate cubings casted from this composition are 6.

Further, the Mortar test is utilized to determine the compressive strength of each of the plurality of alumino-silicate cubings, each having size of 150×150×150 millimeters (as described above). Each of the plurality of alumino-silicate cubings attains a cube crushing strength of 11 Mega Pascal in 3 days, a cube crushing strength of 20 Mega Pascal in 7 days, a cube crushing strength of 23 Mega Pascal in 14 days and a cube crushing strength of 25 Mega Pascal in 21 days.

The second case includes testing the compressive strength of each of the plurality of alumino-silicate cubings casted from a second composition including the fly ash of about 10 kilograms, the plurality of sand particles of about 8 kilograms, the calcium hydroxide of about 2 kilograms in its solution, the plurality of stone chips of about 30 kilograms along with 3 litres of the alkaline activator. The alkaline activator facilitates the cold setting of the geo-polymer based concrete for gaining the required compressive strength. Moreover, number of the plurality of alumino-silicate cubings casted from this composition are 6.

Further, the Mortar test is utilized to determine the compressive strength of each of the plurality of alumino-silicate cubings, each having size of 150×150×150 millimeters (as described above). Each of the plurality of alumino-silicate cubings attains a cube crushing strength of 14 Mega Pascal in 3 days, a cube crushing strength of 22 Mega Pascal in 7 days, a cube crushing strength of 26 Mega Pascal in 14 days and a cube crushing strength of 31 Mega Pascal in 21 days.

In an embodiment of the present disclosure, the cube crushing strength of the geo-polymer based concrete in each of the cases described above is attained under atmospheric drying exposed to sunlight.

Moreover, presence of the alkaline activator eliminates a heat curing process. The heat curing process involves temperature curing of the geo-polymer based building material (geo-polymer based concrete) in a range of 40-100 degree Celsius to attain a required strength. However, the composition of geo-polymer based building material do not require the so-called much needed heat/temperature curing process, instead it is prepared at ambient conditions (as described in detailed description of FIG. 1 and FIG. 2).

Further, the atmospheric curing performed by utilizing the alkaline activator enables the geo-polymer based concrete to attain the required amount of compressive strength (as stated above). In an embodiment of the present disclosure, each of the plurality of alumino-silicate cubings is de-moulded and exposed for the atmospheric curing. Moreover, various parameters are responsible for influencing the compressive strength of the geo-polymer based concrete (as described elaborately in detailed description of FIG. 1). The flow chart 300 terminates at step 314.

It may be noted that the flow chart 300 is explained to have above stated process steps; however, those skilled in the art would appreciate that the flow chart 300 may have more/less number of process steps which may enable all the above stated embodiments of the present disclosure.

FIG. 4 illustrates a table 400 that describes the applications of the geo-polymer based concrete based on an atomic ratio of the silica to the alumina, in accordance with various embodiments of the present disclosure. It may be noted that to illustrate concepts of FIG. 4, references will be made to the concepts of FIG. 1, FIG. 2 and FIG. 3.

The atomic ratio of the silica to the alumina decides the applications of the geo-polymer based concrete. The geo-polymer based concrete having the ratio of the silica to the alumina of 1 founds its applications in preparation of bricks and ceramics. Further, this offers the excellent fire resistance capabilities. The geo-polymer based concrete having the ratio of the silica to the alumina of 2 is a low carbon dioxide concrete that founds its applications in radioactive and toxic waste encapsulation. Further, the geo-polymer based concrete having the ratio of the silica to the alumina of 3 founds its applications in preparation of foundry equipments and tools for aeronautics titanium process. Further, these are excellent heat resistance composites that can offer resistance up to 200-1000 degree Celsius. Further, the geo-polymer based concrete having the ratio of the silica to the alumina of greater than 3 founds its applications in preparing the aeronautics tools and sealants for various industries. The geo-polymer based concrete having the ratio of the silica to the alumina in a range of 20-35 founds its applications in preparing fire resistant and heat resistant fiber composites.

The geo-polymer based concrete is truly a green concrete as the water is required only at the time of preparing the composition and thereafter no water curing is required; thus saving not only huge quantity of water but even labour as the geo-polymer based concrete takes an approximate of 6 hours to stabilize. Furthermore, most of cement concrete structures start deteriorating after about 20 years but the geo-polymer based concrete produced using the fly ash can be more durable.

Other advantages of the geo-polymer based concrete involve its superior mechanical properties with the compressive strength in a range of 10 Mega Pascal to 50 Mega Pascal (as described earlier). Furthermore, the geo-polymer based concrete has a high fire resistance and a high thermal insulation. In addition, the geo-polymer based concrete has a high abrasion resistance. Moreover, the water curing free geo-polymer based concrete is cost competitive and leads to 10 to 25% reduction in cost. Most importantly, the geo-polymer based concrete is environmental friendly that reduces about 80% carbon dioxide emissions in atmosphere in comparison to ordinary Portland cement. Furthermore, the geo-polymer based concrete supports zero waste management by utilizing industrial waste (fly ash). Moreover, high early strength gain during dry-heating or steam curing is a characteristic of the geo-polymer based concrete, although ambient temperature curing is possible for the geo-polymer based concrete. Further, the geo-polymer based concrete has an excellent resistance to chemical attack, for example, against acids, toxic wastes, salty water and the like. This is particularly applicable in aggressive marine environments, environments with high carbon dioxide or sulphate rich soils. Similarly in highly acidic conditions, the geo-polymer based concrete has shown to have superior acid resistance and may be suitable for applications such as mining, some preparing industries, sewer systems and the like. Moreover, bond characteristics of reinforcing bar in the geo-polymer based concrete have been determined to be comparable or even superior to Portland cement concrete.

The following examples are given by way of illustration and therefore should not be construed to limit the scope of the present invention.

### Example 1

The fly ash, the plurality of sand particles and the plurality of stone chips are mixed in a ratio of 1:2:3. An amount of the alkaline activator added to the above mixture is based on molarities of the sodium hydroxide solution in 1:1 and 1:2 volume ratios of the sodium hydroxide solution to the sodium silicate solution.

The Example 1 illustrates a case 1 showing the compressive strength attained by each of the plurality of alumino-silicate cubings when the volume ratio of the sodium hydroxide solution to the sodium silicate solution is 1:1. In a first embodiment, the fly ash, the plurality of sand particles and the plurality of stone chips are mixed in the mixing apparatus for uniform mixing in a ratio of 1:2:3. Further, the calcium hydroxide solution is added in the mixing apparatus which is 15% by weight of the fly ash. Moreover, weight of charged material (the fly ash, the plurality of sand particles and the plurality of stone chips) in the mixing apparatus is 60 kilograms and weight of the calcium hydroxide in 1 litre of its solution is 1.5 kilograms. Moreover, 3 litres of the alkaline activator having a molarity of M2 is added in the mixing apparatus to obtain a wet mixture. In addition, 1.5 litres of a caustic activated fly ash water slurry and 180 millimeters of a slump (based on 300 millimeters height) are added to the wet mixture. Based on a workability of the above wet mixture, an initial setting time of the wet mixture is approximately 30 minutes.

The wet mixture is then used for casting different cubings of size 150×150×150 millimeters. The cubings are exposed to the ambient atmosphere conditions. The cubings exposed in the atmospheric curing attain a compressive crushing strength of 2.5 Mega Pascal after 3 days, 5.8 Mega Pascal after 7 days and 10.2 Mega Pascal after 28 days. In an embodiment of the present disclosure, the casted cubings are the plurality of alumino-silicate cubings discussed earlier in the detailed description.

In a second embodiment, the fly ash, the plurality of sand particles and the plurality of stone chips are mixed in the mixing apparatus for uniform mixing in the ratio of 1:2:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 60 kilograms and weight of the calcium hydroxide in 1 litre of its solution is 1.5 kilograms. Moreover, 3 litres of the alkaline activator having a molarity of M4 is added in the mixing apparatus to obtain a wet mixture. In addition, 1.5 litres of the caustic activated fly ash water slurry and 180 millimeters of the slump (based on 300 millimeters height) are added to the wet mixture. Based on a workability of the above wet mixture, an initial setting time of the wet mixture is approximately 25 minutes.

The wet mixture is then used for casting different cubings of size 150×150×150 millimeters. The cubings are exposed to the ambient atmosphere conditions. The cubings exposed in the atmospheric curing attain a compressive crushing strength of 4.5 Mega Pascal after 3 days, 6.3 Mega Pascal after 7 days and 13.4 Mega Pascal after 28 days. In an embodiment of the present disclosure, the casted cubings are the plurality of alumino-silicate cubings discussed earlier in the detailed description.

In a third embodiment, the fly ash, the plurality of sand particles and the plurality of stone chips are mixed in the mixing apparatus for uniform mixing in the ratio of 1:2:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 60 kilograms and weight of the calcium hydroxide in 1 litre of its solution is 1.5 kilograms. Moreover, 3 litres of the alkaline activator having a molarity of M6 is added in the mixing apparatus to obtain a wet mixture. In addition, 1.5 litres of the caustic activated fly ash water slurry and 180 millimeters of the slump (based on 300 millimeters height) are added to the wet mixture. Based on a workability of the above wet mixture, an initial setting time of the wet mixture is approximately 25 minutes.

The wet mixture is then used for casting different cubings of size 150×150×150 millimeters. The cubings are exposed to the ambient atmosphere conditions. The cubings exposed in the atmospheric curing attain a compressive crushing strength of 6.2 Mega Pascal after 3 days, 11.1 Mega Pascal after 7 days and 16.5 Mega Pascal after 28 days. In an embodiment of the present disclosure, the casted cubings are the plurality of alumino-silicate cubings discussed earlier in the detailed description.

In a fourth embodiment, the fly ash, the plurality of sand particles and the plurality of stone chips are mixed in the mixing apparatus for uniform mixing in the ratio of 1:2:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 60 kilograms and weight of the calcium hydroxide in 1 litre of its solution is 1.5 kilograms. Moreover, 3 litres of the alkaline activator having a molarity of M8 is added in the mixing apparatus to obtain a wet mixture. In addition, 1.5 litres of the caustic activated fly ash water slurry and 180 millimeters of the slump (based on 300 millimeters height) are added to the wet mixture. Based on a workability of the above wet mixture, an initial setting time of the wet mixture is approximately 25 minutes.

The wet mixture is then used for casting different cubings of size 150×150×150 millimeters. The cubings are exposed to the ambient atmosphere conditions. The cubings exposed in the atmospheric curing attain a compressive crushing strength of 7.4 Mega Pascal after 3 days, 14.3 Mega Pascal after 7 days and 18.7 Mega Pascal after 28 days. In an embodiment of the present disclosure, the casted cubings are the plurality of alumino-silicate cubings discussed earlier in the detailed description.

In a fifth embodiment, the fly ash, the plurality of sand particles and the plurality of stone chips are mixed in the mixing apparatus for uniform mixing in the ratio of 1:2:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 60 kilograms and weight of the calcium hydroxide in 1 litre of its solution is 1.5 kilograms. Moreover, 3 litres of the alkaline activator having a molarity of M10 is added in the mixing apparatus to obtain a wet mixture. In addition, 1.5 litres of the caustic activated fly ash water slurry and 180 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 10.2 Mega Pascal after 3 days, 16.7 Mega Pascal after 7 days and 21.3 Mega Pascal after 28 days. In an embodiment of the present disclosure, the casted cubings are the plurality of alumino-silicate cubings discussed earlier in the detailed description.

In a sixth embodiment, the fly ash, the plurality of sand particles and the plurality of stone chips are mixed in the mixing apparatus for uniform mixing in the ratio of 1:2:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 60 kilograms and weight of the calcium hydroxide in 1 litre of its solution is 1.2 kilograms. Moreover, 3 litres of the alkaline activator having a molarity of M12 is added in the mixing apparatus to obtain a wet mixture. In addition, 1.5 litres of the caustic activated fly ash water slurry and 180 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 12.6 Mega Pascal after 3 days, 22.7 Mega Pascal after 7 days and 28.5 Mega Pascal after 28 days. In an embodiment of the present disclosure, the casted cubings are the plurality of alumino-silicate cubings discussed earlier in the detailed description.

It can be inferred from the case 1 that the plurality of alumino-silicate cubings casted from the geo-polymer based building material having the 1:2:3 ratio of the fly ash, the plurality of sand particles and the plurality of stone chips with the molarities M6, M8, M10 and M12 attain the compressive crushing strength in a range of 16-28 Mega Pascal within an approximate period of 28 days.

Further, the Example 1 illustrates a case 2 showing the compressive strength attained by the plurality of alumino-silicate cubings when the volume ratio of the sodium hydroxide solution to the sodium silicate solution is 1:2.

It may be noted that composition of the wet mixture utilized for describing a first embodiment of the case 2 is similar to the composition of the wet mixture utilized for describing the first embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 2.8 Mega Pascal after 3 days, 6.4 Mega Pascal after 7 days and 12.7 Mega Pascal after 28 days. In an embodiment of the present disclosure, the casted cubings are the plurality of alumino-silicate cubings discussed earlier in the detailed description.

Further, it may be noted that composition of the wet mixture utilized for describing a second embodiment of the case 2 is similar to the composition of the wet mixture utilized for describing the second embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 6.8 Mega Pascal after 3 days, 9.3 Mega Pascal after 7 days and 16.4 Mega Pascal after 28 days. In an embodiment of the present disclosure, the casted cubings are the plurality of alumino-silicate cubings discussed earlier in the detailed description.

Further, it may be noted that composition of the wet mixture utilized for describing a third embodiment of the case 2 is similar to the composition of the wet mixture utilized for describing the third embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 8.8 Mega Pascal after 3 days, 16.1 Mega Pascal after 7 days and 21.5 Mega Pascal after 28 days. In an embodiment of the present disclosure, the casted cubings are the plurality of alumino-silicate cubings discussed earlier in the detailed description.

Further, it may be noted that composition of the wet mixture utilized for describing a fourth embodiment of the case 2 is similar to the composition of the wet mixture utilized for describing the fourth embodiment of the case 1. Based on a workability of the above wet mixture, an initial setting time of the wet mixture is approximately 20 minutes. The wet mixture is then used for casting different cubings of size 150×150×150 millimeters. The cubings are exposed to the ambient atmosphere conditions. The cubings exposed in the atmospheric curing attain a compressive crushing strength of 10.8 Mega Pascal after 3 days, 18.7 Mega Pascal after 7 days and 23.7 Mega Pascal after 28 days. In an embodiment of the present disclosure, the casted cubings are the plurality of alumino-silicate cubings discussed earlier in the detailed description.

Further, it may be noted that composition of the wet mixture utilized for describing a fifth embodiment of the case 2 is similar to the composition of the wet mixture utilized for describing the fifth embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 12.2 Mega Pascal after 3 days, 20.7 Mega Pascal after 7 days and 28.1 Mega Pascal after 28 days. In an embodiment of the present disclosure, the casted cubings are the plurality of alumino-silicate cubings discussed earlier in the detailed description.

In a sixth embodiment, the fly ash, the plurality of sand particles and the plurality of stone chips are mixed in a mixing apparatus for uniform mixing in a ratio of 1:2:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 60 kilograms and weight of the calcium hydroxide in 1 litre of its solution is 1.5 kilograms. Moreover, 3 litres of the alkaline activator having a molarity of M12 is added in the mixing apparatus to obtain a wet mixture. In addition, 1.5 litres of the caustic activated fly ash water slurry and 180 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to ambient atmosphere conditions. The cubings exposed in the atmospheric curing attain a compressive crushing strength of 15.6 Mega Pascal after 3 days, 24.7 Mega Pascal after 7 days and 32.5 Mega Pascal after 28 days. In an embodiment of the present disclosure, the casted cubings are the plurality of alumino-silicate cubings discussed earlier in the detailed description.

It can be inferred from the case 2 that the plurality of alumino-silicate cubings casted from the geo-polymer based building material having the 1:2:3 ratio of the fly ash, the plurality of sand particles and the plurality of stone chips with the molarities M4, M6, M8, M10 and M12 attain the compressive crushing strength in a range of 16-32 Mega Pascal within the approximate period of 28 days.

### Example 2

The fly ash, the plurality of sand particles and the plurality of stone chips are mixed in a ratio of 1:1.5:3. An amount of the alkaline activator added to the above mixture is based on molarities of the sodium hydroxide solution in 1:1 and 1:2 volume ratios of the sodium hydroxide solution to the sodium silicate solution.

The Example 2 illustrates a case 1 showing the compressive strength attained by each of the plurality of alumino-silicate cubings when the volume ratio of the sodium hydroxide solution to the sodium silicate solution is 1:1. In a first embodiment, the fly ash, the plurality of sand particles and the plurality of stone chips are mixed in the mixing apparatus for uniform mixing in a ratio of 1:1.5:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 55 kilograms and weight of the calcium hydroxide in 1 litre of its solution is 1.5 kilograms. Moreover, 3 litres of the alkaline activator having a molarity of M2 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 30 minutes.

The wet mixture is then used for casting different cubings of size 150×150×150 millimeters. The cubings are exposed to the ambient atmosphere conditions. The cubings exposed in the atmospheric curing attain a compressive crushing strength of 4.5 Mega Pascal after 3 days, 7.4 Mega Pascal after 7 days and 12.6 Mega Pascal after 28 days. In an embodiment of the present disclosure, the casted cubings are the plurality of alumino-silicate cubings discussed earlier in the detailed description.

In a second embodiment, the fly ash, the plurality of sand particles and the plurality of stone chips are mixed in the mixing apparatus for uniform mixing in the ratio of 1:1.5:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 55 kilograms and weight of the calcium hydroxide in 1 litre of its solution is 1.5 kilograms. Moreover, 3 litres of the alkaline activator having a molarity of M4 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 5.7 Mega Pascal after 3 days, 8.9 Mega Pascal after 7 days and 16.0 Mega Pascal after 28 days. In an embodiment of the present disclosure, the casted cubings are the plurality of alumino-silicate cubings discussed earlier in the detailed description.

In a third embodiment, the fly ash, the plurality of sand particles and the plurality of stone chips are mixed in the mixing apparatus for uniform mixing in the ratio of 1:1.5:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 55 kilograms and weight of the calcium hydroxide in 1 litre of its solution is 1.5 kilograms. Moreover, 3 litres of the alkaline activator having a molarity of M6 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 25 minutes.

The wet mixture is then used for casting different cubings of size 150×150×150 millimeters. The cubings are exposed to the ambient atmosphere conditions. The cubings exposed in the atmospheric curing attain a compressive crushing strength of 8.3 Mega Pascal after 3 days, 14.1 Mega Pascal after 7 days and 20.2 Mega Pascal after 28 days. In an embodiment of the present disclosure, the casted cubings are the plurality of alumino-silicate cubings discussed earlier in the detailed description.

In a fourth embodiment, the fly ash, the plurality of sand particles and the plurality of stone chips are mixed in the mixing apparatus for uniform mixing in the ratio of 1:1.5:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 55 kilograms and weight of the calcium hydroxide in 1 litre of its solution is 1.5 kilograms. Moreover, 3 litres of the alkaline activator having a molarity of M8 is added in the mixing apparatus to obtain a wet mixture. In addition, 1.5 litres of the caustic activated fly ash water slurry and 200 millimeters of the slump (based on 300 millimeters height) are added to the wet mixture. Based on workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 11.7 Mega Pascal after 3 days, 17.5 Mega Pascal after 7 days and 24.2 Mega Pascal after 28 days. In an embodiment of the present disclosure, the casted cubings are the plurality of alumino-silicate cubings discussed earlier in the detailed description.

In a fifth embodiment, the fly ash, the plurality of sand particles and the plurality of stone chips are mixed in the mixing apparatus for uniform mixing in the ratio of 1:1.5:3. Further, the calcium hydroxide solution is added in the mixing apparatus which is 15% by weight of the fly ash. Moreover, weight of charged material (the fly ash, the plurality of sand particles and the plurality of stone chips) in the mixing apparatus is 55 kilograms and weight of the calcium hydroxide in 1 litre of its solution is 1.5 kilograms. Moreover, 3 litres of the alkaline activator having a molarity of M10 is added in the mixing apparatus to obtain a wet mixture. In addition, 1.5 litres of the caustic activated fly ash water slurry and 200 millimeters of the slump (based on 300 millimeters height) are added to the wet mixture. Based on workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 13.4 Mega Pascal after 3 days, 20.6 Mega Pascal after 7 days and 28.5 Mega Pascal after 28 days. In an embodiment of the present disclosure, the casted cubings are the plurality of alumino-silicate cubings discussed earlier in the detailed description.

In a sixth embodiment, the fly ash, the plurality of sand particles and the plurality of stone chips are mixed in the mixing apparatus for uniform mixing in the ratio of 1:1.5:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 55 kilograms and weight of the calcium hydroxide in 1 litre of its solution is 1.1 kilograms. Moreover, 3 litres of the alkaline activator having a molarity of M12 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 16.7 Mega Pascal after 3 days, 24.8 Mega Pascal after 7 days and 34.3 Mega Pascal after 28 days. In an embodiment of the present disclosure, the casted cubings are the plurality of alumino-silicate cubings discussed earlier in the detailed description.

It can be inferred from the case 1 that the plurality of alumino-silicate cubings casted from the geo-polymer based building material having the 1:1.5:3 ratio of the fly ash, the plurality of sand particles and the plurality of stone chips with the molarities M4, M6, M8, M10 and M12 attain the compressive crushing strength in a range of 16-34 Mega Pascal within the approximate period of 28 days.

Further, the Example 2 illustrates a case 2 showing the compressive strength attained by each of the plurality of alumino-silicate cubings when the volume ratio of the sodium hydroxide solution to the sodium silicate solution is 1:2.

It may be noted that composition of the wet mixture utilized for describing a first embodiment of the case 2 is similar to the composition of the wet mixture utilized for describing the first embodiment of the case 1. Based on a workability of the above wet mixture, an initial setting time of the wet mixture is approximately 25 minutes. The wet mixture is then used for casting different cubings of size 150×150×150 millimeters. The cubings are exposed to the ambient atmosphere conditions. The cubings exposed in the atmospheric curing attain a compressive crushing strength of 5.1 Mega Pascal after 3 days, 8.4 Mega Pascal after 7 days and 14.6 Mega Pascal after 28 days. In an embodiment of the present disclosure, the casted cubings are the plurality of alumino-silicate cubings discussed earlier in the detailed description.

Further, it may be noted that composition of the wet mixture utilized for describing a second embodiment of the case 2 is similar to the composition of the wet mixture utilized for describing the second embodiment of the case 1. Based on a workability of the above wet mixture, an initial setting time of the wet mixture is approximately 20 minutes. The wet mixture is then used for casting different cubings of size 150×150×150 millimeters. The cubings are exposed to the ambient atmosphere conditions. The cubings exposed in the atmospheric curing attain a compressive crushing strength of 7.2 Mega Pascal after 3 days, 11.9 Mega Pascal after 7 days and 18.8 Mega Pascal after 28 days. In an embodiment of the present disclosure, the casted cubings are the plurality of alumino-silicate cubings discussed earlier in the detailed description.

Further, it may be noted that composition of the wet mixture utilized for describing a third embodiment of the case 2 is similar to the composition of the wet mixture utilized for describing the third embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 10.6 Mega Pascal after 3 days, 18.7 Mega Pascal after 7 days and 26.1 Mega Pascal after 28 days. In an embodiment of the present disclosure, the casted cubings are the plurality of alumino-silicate cubings discussed earlier in the detailed description.

Further, it may be noted that composition of the wet mixture utilized for describing a fourth embodiment of the case 2 is similar to the composition of the wet mixture utilized for describing the fourth embodiment of the case 1. Based on a workability of the above wet mixture, an initial setting time of the wet mixture is approximately 20 minutes. The wet mixture is then used for casting different cubings of size 150×150×150 millimeters. The cubings are exposed to the ambient atmosphere conditions. The cubings exposed in the atmospheric curing attain a compressive crushing strength of 14.2 Mega Pascal after 3 days, 21.5 Mega Pascal after 7 days and 27.2 Mega Pascal after 28 days. In an embodiment of the present disclosure, the casted cubings are the plurality of alumino-silicate cubings discussed earlier in the detailed description.

Further, it may be noted that composition of the wet mixture utilized for describing a fifth embodiment of the case 2 is similar to the composition of the wet mixture utilized for describing the fifth embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 14.4 Mega Pascal after 3 days, 23.6 Mega Pascal after 7 days and 33.5 Mega Pascal after 28 days. In an embodiment of the present disclosure, the casted cubings are the plurality of alumino-silicate cubings discussed earlier in the detailed description.

In a sixth embodiment, the fly ash, the plurality of sand particles and the plurality of stone chips are mixed in the mixing apparatus for uniform mixing in the ratio of 1:1.5:3. Further, the calcium hydroxide in 1 litre of its solution is added in the mixing apparatus which is 15% by weight of the fly ash. Moreover, weight of the charged material (the fly ash, the plurality of sand particles and the plurality of stone chips) in the mixing apparatus is 55 kilograms and weight of the calcium hydroxide in 1 litre of its solution is 1.5 kilograms. Moreover, 3 litres of the alkaline activator having a molarity of M12 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 17.6 Mega Pascal after 3 days, 28.8 Mega Pascal after 7 days and 36.2 Mega Pascal after 28 days. In an embodiment of the present disclosure, the casted cubings are the plurality of alumino-silicate cubings discussed earlier in the detailed description.

It can be inferred from the case 2 that each of the plurality of alumino-silicate cubings casted from the geo-polymer based building material having the 1:1.5:3 ratio of the fly ash, the plurality of sand particles and the plurality of stone chips with the molarities M4, M6, M8, M10 and M12 attain the compressive crushing strength in a range of 18-36 Mega Pascal within the approximate period of 28 days.

### Example 3

The fly ash, the plurality of sand particles and the plurality of stone chips are mixed in a ratio of 1:1:3. An amount of the alkaline activator added to the above mixture is based on molarities of the sodium hydroxide solution in 1:1 and 1:2 volume ratios of the sodium hydroxide solution to the sodium silicate solution.

The Example 3 illustrates a case 1 showing the compressive strength attained by each of the plurality of alumino-silicate cubings when the volume ratio of the sodium hydroxide solution to the sodium silicate solution is 1:1. In a first embodiment, the fly ash, the plurality of sand particles and the plurality of stone chips are mixed in the mixing apparatus for uniform mixing in the ratio of 1:1:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 50 kilograms and weight of the calcium hydroxide in 1 litre of its solution is 1.5 kilograms. Moreover, 3 litres of the alkaline activator having a molarity of M2 is added in the mixing apparatus to obtain a wet mixture. In addition, 1.5 litres of the caustic activated fly ash water slurry and 160 millimeters of the slump (based on 300 millimeters height) are added to the wet mixture. Based on a workability of the above wet mixture, an initial setting time of the wet mixture is approximately 25 minutes.

The wet mixture is then used for casting different cubings of size 150×150×150 millimeters. The cubings are exposed to the ambient atmosphere conditions. The cubings exposed in the atmospheric curing attain a compressive crushing strength of 5.5 Mega Pascal after 3 days, 8.6 Mega Pascal after 7 days and 14.1 Mega Pascal after 28 days. In an embodiment of the present disclosure, the casted cubings are the plurality of alumino-silicate cubings discussed earlier in the detailed description.

In a second embodiment, the fly ash, the plurality of sand particles and the plurality of stone chips are mixed in the mixing apparatus for uniform mixing in the ratio of 1:1:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 50 kilograms and weight of the calcium hydroxide in 1 litre of its solution is 1.5 kilograms. Moreover, 3 litres of the alkaline activator having a molarity of M4 is added in the mixing apparatus to obtain a wet mixture. In addition, 1.5 litres of the caustic activated fly ash water slurry and 160 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 7.2 Mega Pascal after 3 days, 11.2 Mega Pascal after 7 days and 17.8 Mega Pascal after 28 days. In an embodiment of the present disclosure, the casted cubings are the plurality of alumino-silicate cubings discussed earlier in the detailed description.

In a third embodiment, the fly ash, the plurality of sand particles and the plurality of stone chips are mixed in the mixing apparatus for uniform mixing in the ratio of 1:1:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 50 kilograms and weight of the calcium hydroxide solution is 1.5 kilograms. Moreover, 3 litres of the alkaline activator having a molarity of M6 is added in the mixing apparatus to obtain a wet mixture. In addition, 1.5 litres of the caustic activated fly ash water slurry and 160 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 9.9 Mega Pascal after 3 days, 15.7 Mega Pascal after 7 days and 21.7 Mega Pascal after 28 days. In an embodiment of the present disclosure, the casted cubings are the plurality of alumino-silicate cubings discussed earlier in the detailed description.

In a fourth embodiment, the fly ash, the plurality of sand particles and the plurality of stone chips are mixed in the mixing apparatus for uniform mixing in the ratio of 1:1:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 50 kilograms and weight of the calcium hydroxide in 1 litre of its solution is 1.5 kilograms. Moreover, 3 litres of the alkaline activator having a molarity of M8 is added in the mixing apparatus to obtain a wet mixture. In addition, 1.5 litres of the caustic activated fly ash water slurry and 160 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 12.9 Mega Pascal after 3 days, 19.7 Mega Pascal after 7 days and 26.5 Mega Pascal after 28 days. In an embodiment of the present disclosure, the casted cubings are the plurality of alumino-silicate cubings discussed earlier in the detailed description.

In a fifth embodiment, the fly ash, the plurality of sand particles and the plurality of stone chips are mixed in the mixing apparatus for uniform mixing in the ratio of 1:1:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 50 kilograms and weight of the calcium hydroxide in 1 litre of its solution is 1.5 kilograms. Moreover, 3 litres of the alkaline activator having a molarity of M10 is added in the mixing apparatus to obtain a wet mixture. In addition, 1.5 litres of the caustic activated fly ash water slurry and 160 millimeters of the slump (based on 300 millimeters height) are added to the wet mixture. Based on workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 14.9 Mega Pascal after 3 days, 24.8 Mega Pascal after 7 days and 30.2 Mega Pascal after 28 days. In an embodiment of the present disclosure, the casted cubings are the plurality of alumino-silicate cubings discussed earlier in the detailed description.

In a sixth embodiment, the fly ash, the plurality of sand particles and the plurality of stone chips are mixed in the mixing apparatus for uniform mixing in the ratio of 1:1:3. Further, the calcium hydroxide solution is added in the mixing apparatus which is 15% by weight of the fly ash. Moreover, weight of the charged material (the fly ash, the plurality of sand particles and the plurality of stone chips) in the mixing apparatus is 50 kilograms and weight of the calcium hydroxide in 1 litre of its solution is 1.0 kilogram. Moreover, 3 litres of the alkaline activator having a molarity of M12 is added in the mixing apparatus to obtain a wet mixture. In addition, 1.5 litres of the caustic activated fly ash water slurry and 160 millimeters of the slump (based on 300 millimeters height) are added to the wet mixture. Based on a workability of the above wet mixture, an initial setting time of the wet mixture is approximately 20 minutes.

The wet mixture is then used for casting different cubings of size 150×150×150 millimeters. The cubings are exposed to the ambient atmosphere conditions. The cubings exposed in the atmospheric curing attain a compressive crushing strength of 19.2 Mega Pascal after 3 days, 26.6 Mega Pascal after 7 days and 36.2 Mega Pascal after 28 days. In an embodiment of the present disclosure, the casted cubings are the plurality of alumino-silicate cubings discussed earlier in the detailed description.

It can be inferred from the case 1 that each of the plurality of alumino-silicate cubings casted from the geo-polymer based building material having the 1:1.5:3 ratio of the fly ash, the plurality of sand particles and the plurality of stone chips with the molarities M4, M6, M8, M10 and M12 attain the compressive crushing strength in a range of 17-36 Mega Pascal within the approximate period of 28 days.

Further, the Example 3 illustrates a case 2 showing the compressive strength attained by each of the plurality of alumino-silicate cubings when the volume ratio of the sodium hydroxide solution to the sodium silicate solution is 1:2.

It may be noted that composition of the wet mixture utilized for describing a first embodiment of the case 2 is similar to the composition of the wet mixture utilized for describing the first embodiment of the case 1. Based on a workability of the above wet mixture, an initial setting time of the wet mixture is approximately 25 minutes. The wet mixture is then used for casting different cubings of size 150×150×150 millimeters. The cubings are exposed to the ambient atmosphere conditions. The cubings exposed in the atmospheric curing attain a compressive crushing strength of 5.8 Mega Pascal after 3 days, 10.6 Mega Pascal after 7 days and 16.4 Mega Pascal after 28 days. In an embodiment of the present disclosure, the casted cubings are the plurality of alumino-silicate cubings discussed earlier in the detailed description.

Further, it may be noted that composition of the wet mixture utilized for describing a second embodiment of the case 2 is similar to the composition of the wet mixture utilized for describing the second embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 9.2 Mega Pascal after 3 days, 14.2 Mega Pascal after 7 days and 20.7 Mega Pascal after 28 days. In an embodiment of the present disclosure, the casted cubings are the plurality of alumino-silicate cubings discussed earlier in the detailed description.

Further, it may be noted that composition of the wet mixture utilized for describing a third embodiment of the case 2 is similar to the composition of the wet mixture utilized for describing the third embodiment of the case 1. The wet mixture is then used for casting different cubings of size 150×150×150 millimeters. The cubings are exposed to the ambient atmosphere conditions. The cubings exposed in the atmospheric curing attain a compressive crushing strength of 12.2 Mega Pascal after 3 days, 20.3 Mega Pascal after 7 days and 28.8 Mega Pascal after 28 days. In an embodiment of the present disclosure, the casted cubings are the plurality of alumino-silicate cubings discussed earlier in the detailed description.

Further, it may be noted that composition of the wet mixture utilized for describing a fourth embodiment of the case 2 is similar to the composition of the wet mixture utilized for describing the fourth embodiment of the case 1. Based on a workability of the above wet mixture, an initial setting time of the wet mixture is approximately 20 minutes. The wet mixture is then used for casting different cubings of size 150×150×150 millimeters. The cubings are exposed to the ambient atmosphere conditions. The cubings exposed in the atmospheric curing attain a compressive crushing strength of 15.9 Mega Pascal after 3 days, 23.7 Mega Pascal after 7 days and 33.0 Mega Pascal after 28 days.

Further, it may be noted that composition of the wet mixture utilized for describing a fifth embodiment of the case 2 is similar to the composition of the wet mixture utilized for describing the fifth embodiment of the case 1. Based on a workability of the above wet mixture, an initial setting time of the wet mixture is approximately 15 minutes. The wet mixture is then used for casting different cubings of size 150×150×150 millimeters. The cubings are exposed to the ambient atmosphere conditions. The cubings exposed in the atmospheric curing attain a compressive crushing strength of 15.9 Mega Pascal after 3 days, 24.8 Mega Pascal after 7 days and 35.2 Mega Pascal after 28 days. In an embodiment of the present disclosure, the casted cubings are the plurality of alumino-silicate cubings discussed earlier in the detailed description.

Further, it may be noted that composition of the wet mixture utilized for describing a sixth embodiment of the case 2 is similar to the composition of the wet mixture utilized for describing the sixth embodiment of the case 1. Based on a workability of the above wet mixture, an initial setting time of the wet mixture is approximately 15 minutes.

The wet mixture is then used for casting different cubings of size 150×150×150 millimeters. The cubings are exposed to the ambient atmosphere conditions. The cubings exposed in the atmospheric curing attain a compressive crushing strength of 18.2 Mega Pascal after 3 days, 32.5 Mega Pascal after 7 days and 42.2 Mega Pascal after 28 days.

It can be inferred from the case 2 that the plurality of alumino-silicate cubings casted from the geo-polymer based building material having the 1:1:3 ratio of the fly ash, the plurality of sand particles and the plurality of stone chips with the molarities M2, M4, M6, M8, M10 and M12 attain the compressive crushing strength in a range of 16-42 Mega Pascal within the approximate period of 28 days.

### Example 4

The plurality of red mud aggregates and the fly ash, the plurality of sand particles and the plurality of stone chips are mixed in a ratio of 1:2:3. In an embodiment of the present disclosure, each of the plurality of red mud aggregates and the fly ash utilized are equal in weight proportion.

The Example 4 illustrates the compressive strength attained by each of the plurality of alumino-silicate cubings when the volume ratio of the sodium hydroxide solution to the sodium silicate solution is 1:1. In a first embodiment, the plurality of red mud aggregates and the fly ash, the plurality of sand particles and the plurality of stone chips are mixed in the mixing apparatus for uniform mixing in the ratio of 1:2:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 60 kilograms and weight of the calcium hydroxide in 1 litre of its solution is 2.0 kilograms. Moreover, 3 litres of the alkaline activator having a molarity M4 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 30 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 2.0 Mega Pascal after 3 days, 4.8 Mega Pascal after 7 days and 8.2 Mega Pascal after 28 days.

In a second embodiment, the plurality of red mud aggregates and the fly ash, the plurality of sand particles and the plurality of stone chips are mixed in the mixing apparatus for uniform mixing in the ratio of 1:2:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 60 kilograms and weight of the calcium hydroxide in 1 litre of its solution is 2.0 kilograms. Moreover, 3 litres of the alkaline activator having a molarity of M6 is added in the mixing apparatus to obtain a wet mixture. In addition, 1.5 litres of the caustic activated fly ash water slurry and 210 millimeters of the slump (based on 300 millimeters height) are added to the wet mixture. Based on a workability of the above wet mixture, an initial setting time of the wet mixture is approximately 30 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 4.8 Mega Pascal after 3 days, 8.5 Mega Pascal after 7 days and 14.0 Mega Pascal after 28 days.

In a third embodiment, the plurality of red mud aggregates and the fly ash, the plurality of sand particles and the plurality of stone chips are mixed in the mixing apparatus for uniform mixing in the ratio of 1:2:3. Further, the calcium hydroxide solution is added in the mixing apparatus which is 20% by weight of the fly ash and the plurality of red mud aggregates. Moreover, weight of the charged material (the plurality of red mud aggregates and the fly ash, the plurality of sand particles and the plurality of stone chips) in the mixing apparatus is 60 kilograms and weight of the calcium hydroxide in 1 litre of its solution is 2.0 kilograms. Moreover, 3 litres of the alkaline activator having a molarity of M8 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 30 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 6.5 Mega Pascal after 3 days, 10.8 Mega Pascal after 7 days and 16.5 Mega Pascal after 28 days.

In a fourth embodiment, the plurality of red mud aggregates and the fly ash, the plurality of sand particles and the plurality of stone chips are mixed in the mixing apparatus for uniform mixing in the ratio of 1:2:3. Further, the calcium hydroxide solution is added in the mixing apparatus which is 20% by weight of the fly ash and the plurality of red mud aggregates. Moreover, weight of the charged material (the plurality of red mud aggregates and the fly ash, the plurality of sand particles and the plurality of stone chips) in the mixing apparatus is 60 kilograms and weight of the calcium hydroxide in 1 litre of its solution is 2.0 kilograms. Moreover, 3 litres of the alkaline activator having a molarity of M10 is added in the mixing apparatus to obtain a wet mixture. In addition, 1.5 litres of the caustic activated fly ash water slurry and 220 millimeters of the slump (based on 300 millimeters height) are added to the wet mixture. Based on a workability of the above wet mixture, an initial setting time of the wet mixture is approximately 25 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 8.4 Mega Pascal after 3 days, 14.3 Mega Pascal after 7 days and 18.5 Mega Pascal after 28 days.

It can be inferred that the each of the plurality of alumino-silicate cubings casted from the geo-polymer based building material having the 1:2:3 ratio of the plurality of red mud aggregates and the fly ash, the plurality of sand particles and the plurality of stone chips with the molarities M4, M6, M8 and M10 attain the compressive crushing strength in a range of 13-21 Mega Pascal within the approximate period of 28 days.

### Example 5

The plurality of red mud aggregates and the fly ash, the plurality of sand particles and the plurality of stone chips are mixed in a ratio of 1:1.5:3. In an embodiment of the present disclosure, each of the plurality of red mud aggregates and the fly ash utilized are equal in weight proportion.

The Example 5 illustrates the compressive strength attained by each of the plurality of alumino-silicate cubings when the volume ratio of the sodium hydroxide solution to the sodium silicate solution is 1:1. In a first embodiment, the plurality of red mud aggregates and the fly ash, the plurality of sand particles and the plurality of stone chips are mixed in the mixing apparatus for uniform mixing in the ratio of 1:1.5:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 55 kilograms and weight of the calcium hydroxide in 1 litre of its solution is 2.0 kilograms. Moreover, 3 litres of the alkaline activator having a molarity M4 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 30 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 2.5 Mega Pascal after 3 days, 6.4 Mega Pascal after 7 days and 10.6 Mega Pascal after 28 days.

In a second embodiment, the plurality of red mud aggregates and the fly ash, the plurality of sand particles and the plurality of stone chips are mixed in the mixing apparatus for uniform mixing in the ratio of 1:1.5:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 55 kilograms and weight of the calcium hydroxide in 1 litre of its solution is 2.0 kilograms. Moreover, 3 litres of the alkaline activator having a molarity of M6 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 30 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 5.8 Mega Pascal after 3 days, 10.9 Mega Pascal after 7 days and 17.0 Mega Pascal after 28 days.

In a third embodiment, the plurality of red mud aggregates and the fly ash, the plurality of sand particles and the plurality of stone chips are mixed in the mixing apparatus for uniform mixing in the ratio of 1:1.5:3. Further, the calcium hydroxide solution is added in the mixing apparatus which is 20% by weight of the plurality of red mud aggregates and the fly ash. Moreover, weight of the charged material (the fly ash, the plurality of sand particles and the plurality of stone chips) in the mixing apparatus is 55 kilograms and weight of the calcium hydroxide in 1 litre of its solution is 2.0 kilograms. Moreover, 3 litres of the alkaline activator having a molarity of M8 is added in the mixing apparatus to obtain a wet mixture. In addition, 1.5 litres of the caustic activated fly ash water slurry and 200 millimeters of the slump (based on 300 millimeters height) are added to the wet mixture. Based on a workability of the above wet mixture, an initial setting time of the wet mixture is approximately 25 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 8.3 Mega Pascal after 3 days, 14.5 Mega Pascal after 7 days and 20.8 Mega Pascal after 28 days.

In a fourth embodiment, the plurality of red mud aggregates and the fly ash, the plurality of sand particles and the plurality of stone chips are mixed in a mixing apparatus for uniform mixing in a ratio of 1:1.5:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 55 kilograms and weight of the calcium hydroxide in 1 litre of its solution is 2.0 kilograms. Moreover, 3 litres of the alkaline activator having a molarity of M10 is added in the mixing apparatus to obtain a wet mixture. In addition, 1.5 litres of the caustic activated fly ash water slurry and 220 millimeters of a slump (based on 300 millimeters height) are added to the wet mixture. Based on a workability of the above wet mixture, an initial setting time of the wet mixture is approximately 20 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 10.7 Mega Pascal after 3 days, 17.8 Mega Pascal after 7 days and 24.8 Mega Pascal after 28 days.

It can be inferred that each of the plurality of alumino-silicate cubings casted from the geo-polymer based building material having the 1:1.5:3 ratio of the plurality of red mud aggregates and the fly ash, the plurality of sand particles and the plurality of stone chips with the molarities M4, M6, M8 and M10 attain the compressive crushing strength in a range of 12-24 Mega Pascal within the approximate period of 28 days.

### Example 6

The plurality of red mud aggregates and the fly ash, the plurality of sand particles and the plurality of stone chips are mixed in a ratio of 1:1:3. In an embodiment of the present disclosure, each of the plurality of red mud aggregates and the fly ash utilized are equal in weight proportion.

The Example 6 illustrates the compressive strength attained by each of the plurality of alumino-silicate cubings when the volume ratio of the sodium hydroxide solution to the sodium silicate solution is 1:1. In a first embodiment, the plurality of red mud aggregates and the fly ash, the plurality of sand particles and the plurality of stone chips are mixed in the mixing apparatus for uniform mixing in the ratio of 1:1:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 50 kilograms and weight of the calcium hydroxide in 1 litre of its solution is 2.0 kilograms. Moreover, 3 litres of the alkaline activator having a molarity M4 is added in the mixing apparatus to obtain a wet mixture. In addition, 1.5 litres of the caustic activated fly ash water slurry and 180 millimeters of the slump (based on 300 millimeters height) are added to the wet mixture. Based on workability of the above wet mixture, an initial setting time of the wet mixture is approximately 25 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 3.0 Mega Pascal after 3 days, 7.6 Mega Pascal after 7 days and 14.5 Mega Pascal after 28 days.

In a second embodiment, the plurality of red mud aggregates and the fly ash, the plurality of sand particles and the plurality of stone chips are mixed in the mixing apparatus for uniform mixing in the ratio of 1:1:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 50 kilograms and weight of the calcium hydroxide in the 1 litre of its solution is 2.0 kilograms. Moreover, 3 litres of the alkaline activator having a molarity of M6 is added in the mixing apparatus to obtain a wet mixture. In addition, 1.5 litres of the caustic activated fly ash water slurry and 180 millimeters of the slump (based on 300 millimeters height) are added to the wet mixture. Based on a workability of the above wet mixture, an initial setting time of the wet mixture is approximately 30 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 7.2 Mega Pascal after 3 days, 13.2 Mega Pascal after 7 days and 20.6 Mega Pascal after 28 days.

In a third embodiment, the plurality of red mud aggregates and the fly ash, the plurality of sand particles and the plurality of stone chips are mixed in the mixing apparatus for uniform mixing in the ratio of 1:1:3. Further, the calcium hydroxide solution is added in the mixing apparatus which is 20% by weight of the plurality of red mud aggregates and the fly ash. Moreover, weight of the charged material (the plurality of red mud aggregates, the fly ash, the plurality of sand particles and the plurality of stone chips) in the mixing apparatus is 50 kilograms and weight of the calcium hydroxide in the 1 litre of its solution is 2.0 kilograms. Moreover, 3 litres of the alkaline activator having a molarity of M8 is added in the mixing apparatus to obtain a wet mixture. In addition, 1.5 litres of the caustic activated fly ash water slurry and 220 millimeters of the slump (based on 300 millimeters height) are added to the wet mixture. Based on a workability of the above wet mixture, an initial setting time of the wet mixture is approximately 25 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 9.5 Mega Pascal after 3 days, 17.7 Mega Pascal after 7 days and 23.6 Mega Pascal after 28 days.

In a fourth embodiment, the plurality of red mud aggregates and the fly ash, the plurality of sand particles and the plurality of stone chips are mixed in the mixing apparatus for uniform mixing in the ratio of 1:1:3. Further, the calcium hydroxide solution is added in the mixing apparatus which is 20% by weight of the plurality of red mud aggregates and the fly ash. Moreover, weight of the charged material (the plurality of red mud aggregates and the fly ash, the plurality of sand particles and the plurality of stone chips) in the mixing apparatus is 50 kilograms and weight of the calcium hydroxide in the 1 litre of its solution is 2.0 kilograms. Moreover, 3 litres of the alkaline activator having a molarity of M10 is added in the mixing apparatus to obtain a wet mixture. In addition, 1.5 litres of the caustic activated fly ash water slurry and 230 millimeters of the slump (based on 300 millimeters height) are added to the wet mixture. Based on a workability of the above wet mixture, an initial setting time of the wet mixture is approximately 20 minutes.

The wet mixture is then used for casting the plurality of alumino-silicate cubings of size 150×150×150 millimeters. The plurality of alumino-silicate cubings are exposed to the ambient atmosphere conditions. Each of the plurality of alumino-silicate cubings exposed in the atmospheric curing attain a compressive crushing strength of 12.5 Mega Pascal after 3 days, 20.2 Mega Pascal after 7 days and 27.5 Mega Pascal after 28 days.

It can be inferred that each of the plurality of alumino-silicate cubings casted from the geo-polymer based building material having the 1:1:3 ratio of the plurality of red mud aggregates and the fly ash, the plurality of sand particles and the plurality of stone chips with the molarities M4, M6, M8 and M10 attain the compressive crushing strength in a range of 14-26 Mega Pascal within the approximate period of 28 days.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed:

1. A method of preparing a composition of a geo-polymer based building material, the method comprising:
mixing one or more aggregates and a plurality of chemical ingredients in a mixing apparatus to obtain a geo-polymer concrete mix, wherein the one or more aggregates comprises a plurality of stone chips and a plurality of sand particles, wherein the plurality of chemical ingredients comprises a fly ash and a calcium hydroxide solution, wherein the fly ash comprises one or more alumino-silicate aggregates, and wherein the fly ash, the plurality of sand particles and the calcium hydroxide solution, and the plurality of stone chips are mixed in a first pre-determined ratio; and
chemically activating the obtained geo-polymer concrete mix by adding an alkaline activator, wherein the alkaline activator comprises at least one of hydroxide selected from hydroxides of sodium, potassium and aluminium and at least one of silicate selected from silicates of sodium, potassium and aluminium, water and an accelerator, wherein the at least one of hydroxide and the at least one of silicate are mixed in a second pre-determined ratio, wherein the at least one of hydroxide and the at least one of silicate, and the water are mixed in an approximate ratio of 1:2,
wherein 3 liters of the alkaline activator is added in every 50 kilograms of the geo-polymer concrete mix to obtain the geo-polymer based building material.

2. The method as recited in claim 1, wherein the first pre-determined ratio comprises at least one of 1:1:3, 1:1.5:3 and 1:2:3, and the second pre-determined ratio is in a range of 1.0-1.5:3.0-3.5.

3. The method as recited in claim 1, wherein the accelerator comprises one or more chemicals of alkali and alkaline metal having a quantity in a range of 0.01% to 0.06% by weight of the alkaline activator.

4. The method as recited in claim 1, further comprising adding a plurality of red mud aggregates in the plurality of chemical ingredients, wherein the fly ash and the plurality of red mud aggregates are present in an equal weight proportion along with the calcium hydroxide solution.

5. The method as recited in claim 1, wherein the fly ash and a plurality of red mud aggregates, the plurality of sand particles, and the plurality of stone chips are present in the geo-polymer concrete mix in a ratio of 1:2:3, and wherein the fly ash and the plurality of red mud aggregates are present in an equal weight proportion.

6. The method as recited in claim 1, wherein the fly ash and a plurality of red mud aggregates, the plurality of sand particles, and the plurality of stone chips are present in the geo-polymer concrete mix in a ratio of 1:1.5:3, and wherein the fly ash and the plurality of red mud aggregates are present in an equal weight proportion.

7. The method as recited in claim 1, wherein the fly ash and a plurality of red mud aggregates, the plurality of sand particles, and the plurality of stone chips are present in the geo-polymer concrete mix in a ratio of 1:1:3, wherein the fly ash and the plurality of red mud aggregates are present in an equal weight proportion.

8. The method as recited in claim 1, wherein a caustic fly ash slurry is added in a mixing apparatus to control consistency in mixing.

9. A method of preparing a composition of a geo-polymer based building material, the method comprising:
mixing one or more aggregates and a plurality of chemical ingredients in a mixing apparatus to obtain a geo-polymer concrete mix, wherein the one or more aggregates comprises a plurality of stone chips and a plurality of sand particles, wherein the plurality of chemical ingredients comprises a fly ash and a calcium hydroxide solution, wherein the fly ash comprises one or more alumino-silicate aggregates, and wherein the fly ash, the plurality of sand particles and the calcium hydroxide solution, and the plurality of stone chips are mixed in a first pre-determined ratio;
grinding the geo-polymer concrete mix to obtain a uniform powdered material;
chemically activating the obtained uniform powdered material of the grinded geo-polymer concrete mix by adding an alkaline activator, wherein the alkaline activator comprises at least one of hydroxide selected from hydroxides of sodium, potassium and aluminium and at least one of silicate selected from silicates of sodium, potassium and aluminium, water and an accelerator, wherein the at least one of hydroxide and the at least one of silicate are mixed in a second pre-determined ratio, wherein the at least one of hydroxide and the at least one of silicate, and the water are mixed in an approximate ratio of 1:4, and wherein the accelerator comprises one or more chemicals of alkali and alkaline metal having a quantity in a range of 0.01% to 0.06% by weight of the alkaline activator; and
operating the chemically activated uniform powdered material to obtain the geo-polymer based building material,
wherein 3 liters of the alkaline activator is added in every 50 kilograms of the geo-polymer concrete mix to obtain the geo-polymer based building material.

10. The method as recited in claim 9, wherein the first pre-determined ratio is 1:1:3, 1:1.5:3 and 1:2:3 and the second pre-determined ratio is in a range of 1.0-1.5:3.0-3.5.

11. The method as recited in claim 9, wherein the alkaline activator facilitates an atmosphere curing of the geo-polymer based building material, and wherein the alkaline activator prevents a temperature curing of the geo-polymer based building material.

12. The method as recited in claim 9, wherein strength of the geo-polymer based building material is in a range of 10 Mega Pascal to 50 Mega Pascal.

13. The method as recited in claim 9, wherein dimensions of each of a plurality of alumino-silicate cubings casted from the composition are 150×150×150 millimeters.

14. The method as recited in claim 9, wherein the fly ash is a class F fly ash.

15. The method as recited in claim 9, wherein the fly ash, the plurality of sand particles and the plurality of stone chips are present in the geo-polymer concrete mix in a ratio of 1:2:3.

16. The method as recited in claim 9, wherein the fly ash, the plurality of sand particles and the plurality of stone chips are present in the geo-polymer concrete mix in a ratio of 1:1.5:3.

17. The method as recited in claim 9, wherein the fly ash, the plurality of sand particles and the plurality of stone chips are present in the geo-polymer concrete mix in a ratio of 1:1:3.

18. A method of preparing a composition of a geo-polymer based building material, the method comprising:
mixing one or more aggregates and a plurality of chemical ingredients in a mixing apparatus to obtain a geo-polymer concrete mix, wherein the one or more aggregates comprises a plurality of stone chips and a plurality of sand particles, wherein the plurality of chemical ingredients comprises a fly ash and a calcium hydroxide solution, wherein the fly ash comprises one or more alumino-silicate aggregates, and wherein the fly ash, the plurality of sand particles and the calcium hydroxide solution, and the plurality of stone chips are mixed in a first pre-determined ratio;
grinding the geo-polymer concrete mix to obtain a uniform powdered material;
chemically activating the obtained uniform powdered material of the geo-polymer concrete mix by adding an alkaline activator, wherein the alkaline activator comprises at least one of hydroxide selected from hydroxides of sodium, potassium and aluminium and at least one of silicate selected from silicates of sodium, potassium and aluminium, water and an accelerator, wherein the at least one of hydroxide and the at least one of silicate are mixed in a second pre-determined ratio, wherein the at least one of hydroxide and the at least one of silicate, and the water are mixed in an approximate ratio of 1:6, and wherein the accelerator comprises one or more chemicals of alkali and alkaline metal having a quantity in a range of 0.01% to 0.06% by weight of the alkaline activator; and
operating the chemically activated uniform powdered material to obtain the geo-polymer based building material; and
casting a plurality of alumino-silicate cubings each having dimensions of 150×150×150 millimeters from the geo-polymer based building material,
wherein 3 liters of the alkaline activator is added in every 50 kilograms of the geo-polymer concrete mix to obtain the geo-polymer based building material.

19. The method as recited in claim 18, wherein the first pre-determined ratio is 1:1:3, 1:1.5:3 and 1:2:3 and the second pre-determined ratio is in a range of 1.0-1.5:3.0-3.5.

20. The method as recited in claim 18, wherein a molarity concentration of the at least one of hydroxide is based on a volume ratio of the at least one of hydroxide to the at least one of silicate and a quantity of the at least one of hydroxide mixed in the water to prepare a 1 litre solution of the at least one of hydroxide.
